(19) United States
(12) Patent Application Publication
(10) Pub. No.: US 2023/0372926 A1
(43) Pub. Date: Nov. 23, 2023

(54) MICROFLUIDIC DEVICES AND PROCESSES

(71) Applicants: Bio-Rad Laboratories, Inc., Hercules, CA (US); Bio-Rad Europe GmbH, Basel (CH)

(72) Inventors: Lorenzo Franco Teodoro Petrini, Ticino (CH); Iago Pereiro Pereiro, Zurich (CH); Robert Dean Lovchik, Schönenberg (CH); Anna Fomitcheva Khartchenko, Zurich (CH); Anel Zulji, Wildegg (CH); Govind Kaigala, Rüschlikon (CH); Cristina Boero, Cressier (CH); Olivier Michel Christian Noël, Cressier (CH); Christophe Guex, Cressier (CH); Stéphane Guillod, Cressier (CH); Aurélie Bolon, Cressier (CH)

(21) Appl. No.: 18/227,218

(22) Filed: Jul. 27, 2023

Related U.S. Application Data
(63) Continuation of application No. PCT/US2022/070457, filed on Feb. 1, 2022.
(60) Provisional application No. 63/144,302, filed on Feb. 1, 2021.

(51) Int. Cl. B01L 3/00

(52) U.S. Cl. CPC B01L 3/5027; B01L 13/02; B01L 2300/14; B01L 2200/0642

(57) ABSTRACT

A method comprises providing a microfluidic device including a reservoir; an injection nozzle at the bottom of the reservoir, the injection nozzle being wider at its top than at its bottom; an injection channel below the injection nozzle; and a microfluidic channel below the injection channel. The method further comprises placing fluid in the reservoir, and allowing the fluid to passively flow through the injection nozzle and the injection channel.

### CROSS-REFERENCE TO RELATED APPLICATIONS

This application is a continuation application of International Patent Application No. PCT/US2022/070457 entitled “MICROFLUIDIC DEVICES AND PROCESSES,” filed on Feb. 1, 2022, which claims priority to U.S. Provisional Application No. 63/144,302, entitled “MICROFLUIDIC DEVICES AND PROCESSES,” filed on Feb. 1, 2021, each of which are herein incorporated by reference in their entirety for all purposes.

### BACKGROUND OF THE INVENTION

The present disclosure relates generally to microfluidic probes and other microfluidic devices involving the injection of fluids.

A microfluidic probe is a non-contact microfluidic system combining concepts of hydrodynamic flow confinement (HFC) and scanning probes for yielding a dynamic microfluidic device which may eliminate the need for performing analyses within closed conduits. Typical probes operate under the well-known Hele-Shaw cell approximation, wherein a quasi-2D Stokes flow is generated between two parallel generally flat surfaces—plates—separated by an arbitrarily small gap working in a microfluidic dipole and microfluidic quadrupole configuration. Generally, the method may be used for applications such as patterning protein arrays on flat surfaces, mammalian cell stimulations and manipulations, localized perfusion of tissue slices as well as generating floating concentration gradients. Microfluidic probes have been proposed as a tissue lithography tool, and may allow prospective studies of formalin-fixed, paraffin-embedded tissue sections. The technique has also been used in the microfluidic quadrupole configuration, as a tool for advanced cell chemotaxis studies, wherein it may allow studying cellular dynamics during migration in response to moving concentration gradients.

### BRIEF SUMMARY

According to one aspect, a microfluidic device has inlet geometry, the inlet geometry comprising a reservoir; an injection nozzle at the bottom of the reservoir, the injection nozzle being wider at its top than at its bottom; an injection channel below the injection nozzle; and a microfluidic channel below the injection channel.

According to another aspect, a method comprises providing a microfluidic device including a reservoir; an injection nozzle at the bottom of the reservoir, the injection nozzle being wider at its top than at its bottom; an injection channel below the injection nozzle; and a microfluidic channel below the injection channel. The method further comprises placing fluid in the reservoir, and allowing the fluid to passively flow through the injection nozzle and the injection channel.

According to another aspect, a method comprises providing a microfluidic device including a reservoir; an injection nozzle at the bottom of the reservoir, the injection nozzle being wider at its top than at its bottom; an injection channel below the injection nozzle; and a microfluidic channel below the injection channel. The method further comprises placing an injector into the injection nozzle, and actively injecting a second fluid from the injector into the injection nozzle.

According to another aspect, a method comprises injecting fluid onto a surface using a microfluidic probe, and oscillating the microfluidic probe vertically to facilitate washing of the surface.

According to another aspect, a microfluidic device comprises a supporting structure, and a modular functionalized substrate mounted to the supporting structure.

### BRIEF DESCRIPTION OF THE DRAWINGS

FIG. 1 illustrates a lower oblique partial view of a simple form of microfluidic probe head.

FIG. 2 shows an orthogonal section view of the microfluidic probe head of FIG. 1, held against a plate.

FIGS. 3A-3D illustrate the problem of air entrapment in a microfluidic device.

FIG. 4 illustrates a cross section of inlet geometry in accordance with embodiments of the invention.

FIG. 5 shows simple passive injection through the inlet geometry of FIG. 4, in accordance with embodiments of the invention.

FIG. 6 illustrates a system using the inlet geometry of FIG. 4 to inject fluid into a microfluidic channel, in accordance with embodiments of the invention.

FIG. 7 illustrates active injection in a system using the inlet geometry of FIG. 4, in accordance with embodiments of the invention.

FIG. 8 shows an example of active injection of a first liquid, followed by passive injection of a second, different liquid, in accordance with embodiments of the invention.

FIG. 9 shows the sequential active injection of two different fluids into a microfluidic channel , in accordance with embodiments of the invention.

FIG. 10 shows an example geometry, in which an aperture angle of an injection nozzle is greater than a tip convergence angle of an injector, in accordance with embodiments of the invention.

FIGS. 11A and 11B show two alternative injection geometries, in accordance with embodiments of the invention.

FIG. 12 shows the use of inlet geometry embodying the invention in a linear flow chamber device, in accordance with other embodiments of the invention.

FIG. 13 shows the use of inlet geometry embodying the invention in a radial splash device, in accordance with other embodiments of the invention.

FIG. 14 shows the use of inlet geometry embodying the invention in a radial cup device, in accordance with other embodiments of the invention.

FIG. 15 shows the use of inlet geometry embodying the invention with a hierarchical flow confinement (HFC) device, in accordance with embodiments of the invention.

FIG. 16 illustrates a microfluidic probe for flowing a fluid across a surface, in accordance with embodiments of the invention.

FIGS. 17A-17C show examples of incomplete washing, including red blood cells deposited over a spot pattern.

FIGS. 18A-18C show an oscillatory system and its operation, in accordance with embodiments of the invention.

FIG. 19 shows a comparison of a surface washed using only aspiration, with a surface washed using aspiration plus a vertical displacement technique in accordance with embodiments of the invention.

FIG. 20 illustrates another structure for disposal of particles washed from the reaction area, in accordance with other embodiments of the invention.

FIG. 21 illustrates the use of stopping structures, to avoid damage to a reaction area, in accordance with embodiments of the invention.

FIG. 22 illustrates a surface that has been spotted with antibodies, and a fluid that has been flowed across the surface using a microfluidic probe, in accordance with embodiments of the invention.

FIG. 23 shows a system in accordance with embodiments of the invention, in which a microfluidic probe is carried by a frame that self-aligns to a receptacle.

FIG. 24 shows an alternative arrangement in accordance with other embodiments of the invention, in which the frame remains fixed in relation to receptacle, and a microfluidic probe oscillates vertically in relation to frame.

FIG. 25 shows a conventional process and device, in which a substrate is functionalized by spotting it with antibodies.

FIG. 26 illustrates process of using modular components in a device, in accordance with embodiments of the invention.

FIGS. 27A-27C illustrate various detrimental effects that can occur if a functionalized modular substrate is not held correctly in a device.

FIG. 28 illustrates a technique for holding a functionalized substrate in a supporting structure, in accordance with embodiments of the invention.

FIG. 29 shows an exploded view of a device that holds a functionalized substrate, in accordance with embodiments of the invention.

FIG. 30A and 30B show upper and lower exploded views of a device that holds a functionalized substrate, in accordance with embodiments of the invention.

FIG. 31 shows portion of the device of FIGS. 29 and 30 in more detail.

FIGS. 32A and 32B show a generally rectangular microfluidic device in accordance with embodiments of the invention, in a disassembled state.

FIG. 33 shows another microfluidic device, in accordance with other embodiments of the invention.

FIG. 34 shows a standard 96-well microtiter plate.

FIG. 35 illustrates a clamping plate, having 12 threaded posts on 18 mm centers, in accordance with embodiments of the invention.

FIG. 36 shows two of the clamping plates of FIG. 35 mounted to a modified microtiter plate in accordance with embodiments of the invention.

FIG. 37 shows the assembly of FIG. 34 from the top side.

FIG. 38 shows a sketch of a system having flow channels between reception areas, in accordance with embodiments of the invention.

FIG. 39 shows a functionalized substrate assembled into structure in accordance with other embodiments of the invention.

FIG. 40 shows a functionalized substrate assembled into structure using an adhesive material, in accordance with embodiments of the invention.

FIG. 41 shows a functionalized substrate held into structure using one or more magnets, in accordance with embodiments of the invention.

FIG. 42 illustrates steps of a process of using a microfluidic device, in accordance with embodiments of the invention.

FIGS. 43A and 43B show photographic views of a membrane, before and after sample dilution has been injected into the microfluidic device in a first experiment.

FIG. 44A-44C show photographic views of a membrane in three stages of a second experiment.

FIGS. 45A and 45B show two photographic views of the membrane after the second experiment.

### DETAILED DESCRIPTION OF THE INVENTION

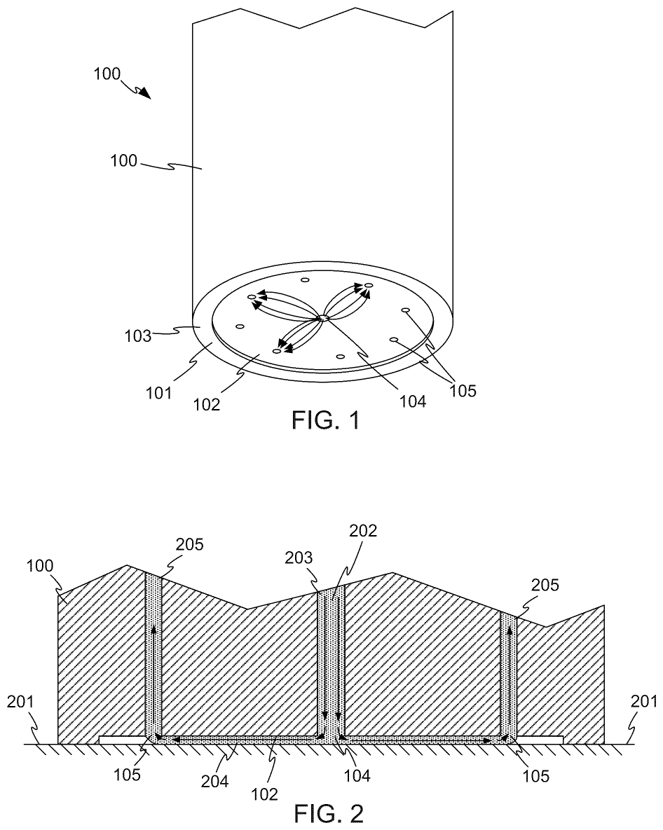

FIG. 1 illustrates a lower oblique partial view of a simple form of microfluidic probe head 100. Microfluidic probe head 100 has a distal end 101, and a proximal end opposite the distal end (out of the view of FIG. 1). Microfluidic probe head 100 also includes a processing surface 102, recessed from distal end 101, leaving an annular surface 103 surrounding processing surface 102. In use, annular surface 103 may be held against a flat plate, and fluid may be dispensed from a central aperture 104. The fluid spreads outward from central aperture 104, coating the plate, and flows toward aspiration apertures 105. Excess fluid may be pulled away from the plate by a partial vacuum applied externally to aspiration apertures 105. Only some of the fluid flows are shown in FIG. 1.

FIG. 2 shows an orthogonal section view of microfluidic probe head 100, held against a plate 201. Fluid 202 flows down central channel 203 to central aperture 104, outward through gap 204 between plate 201 and processing surface 102, through aspiration apertures 105, and upward through aspiration channels 205.

### Inlet Geometry

Other kinds of microfluidic devices, some of which are described below, also perform injection of fluids. There have been two primary approaches for injection—passive injection and active injection.

Passive injection uses simple gravity flow. This approach is less complex than active injection, and is a good choice for applications that do not require specific control over some parameters such as the fluid flow rate. However, many applications are highly sensitive to variations in the flow rate. Furthermore, passive injection does not permit adaption “on-the-run”. Rather, in passive injection the flow rate depends only on the level of liquid in the reservoir.

Active injection uses active means such as pumps, gas pressure, partial vacuum, or other methods to provide impetus for the fluid flow. Active injection allows for accurate control over the injected liquid through an injector, and can be controlled at all times.

However, active injection also has drawbacks. For example, active injection involves more complex operations than passive injection, especially when performing sequential injection. The time involved may be longer, including time to extract a pipettor and reinsert a new one with a subsequent liquid to injection. In addition, more materials may be needed, for example consumable materials such as multiple injectors, or a quick washing system to enable reuse of injectors.

Another drawback of prior systems is that injection of sequential liquids inside a device may lead to entrapment of air gaps into the inlet geometry when the injector is re-inserted into the injection geometry after a precedent injection step. The entrapped air may then be translated inside the device, reducing the performance of the device. Different inlet geometries have been developed to minimize air entrapment, but improvements are still needed.

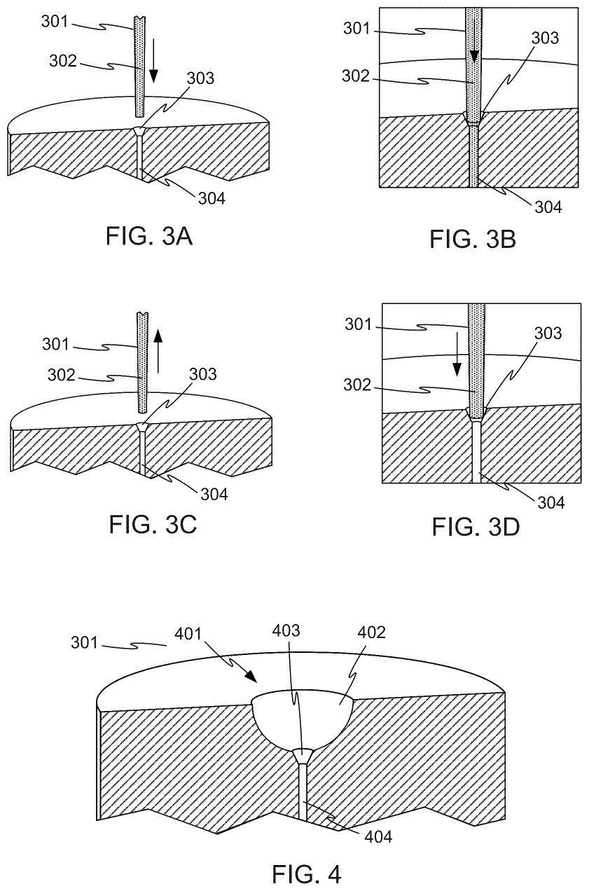

FIGS. 3A-3D illustrate the problem of air entrapment. In FIG. 3A, an injector 301 filled with a fluid 302 approaches inlet geometry 303. Inlet geometry 303 leads to an injection channel 304. For example, injector 301 may be a standard pipette tip or another kind of injector.

In FIG. 3B, injector 301 has engaged inlet geometry 303, sealing against inlet geometry 303, and liquid 302 flows from injector 301 into injection channel 304.

In FIG. 3C, injector 301 has been withdrawn from inlet geometry, disengaging from inlet geometry 303. While liquid 302 still resides in injector 301, any fluid in injection channel 304 has flowed downward and out of injection channel 304.

In FIG. 3D, injector 301 (or another injector) has re-engaged with inlet geometry 303, in preparation for injecting more of fluid 302 (or another fluid) into injection channel 304. However, because injection channel 304 now contains only air, the air will be injected into the system once fluid 302 is again dispensed from injector 301. For the purposes of this disclosure, the terms “fluid” and “liquid” are used interchangeably to mean a liquid.

Embodiments of the invention use a geometry that permits combination of passive and active injection, may reduce or eliminate the entrapment of air in the system, and may reduce or eliminate contamination.

FIG. 4 illustrates a cross section of inlet geometry 401 in accordance with embodiments of the invention. Inlet geometry 401 includes a comparatively large reservoir 402 suitable for performing passive injection. Inlet geometry 401 also includes an injection nozzle 403 similar to inlet geometry 303 described above, for sealing with an external injector tip such as injector 301, for performing active injection. In some embodiments, injection nozzle 403 is wider at its top than at its bottom, and may be cone-shaped. Whether passive or active injection is used, the injected fluid passes to injection channel 404. Use of inlet geometry 401 for passive, active, and combined injection is described in more detail below.

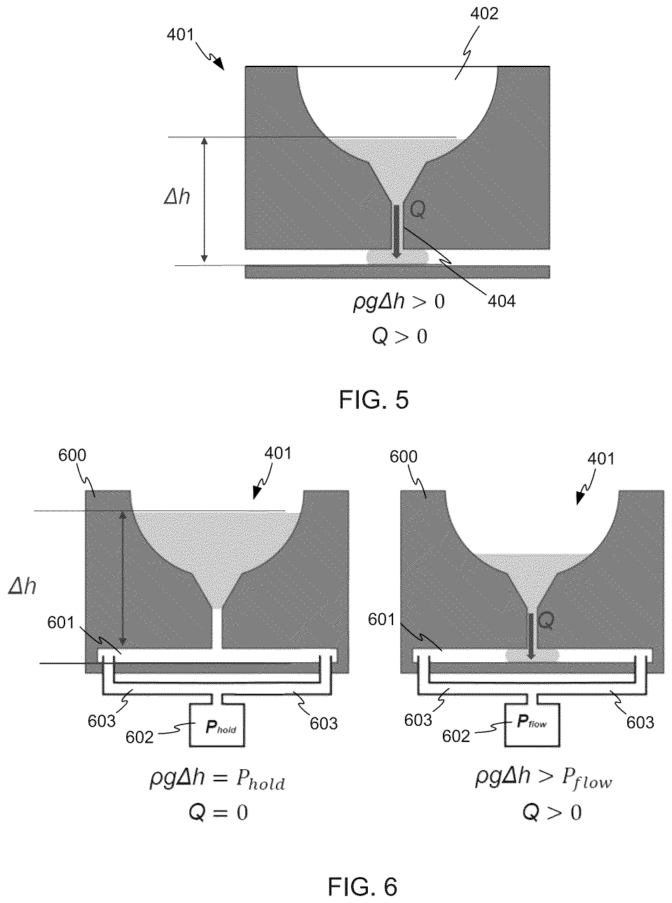

FIG. 5 shows simple passive injection through inlet geometry 401, in accordance with embodiments of the invention. Passive injection results in a net flow of a liquid present in the reservoir 402, driven by hydrostatic pressure inside the device through injection channel 404. The hydrostatic pressure at the outlet of injection channel 404 is given by

P_{hydrostatic}=ρgΔh

where ρ is the density of the liquid in reservoir 402, g is the gravitational constant, and Δh is as shown in FIG. 5. Assuming a density ρ of 1 g/cm and Δh of 1 cm, then P_{hydrostatic}=100 PA =1 mbar.

The hydrostatic pressure decreases with the level of liquid in the reservoir 402. This translates to a reduction of the net flow rate Q in the downstream tubing. This may be acceptable in an application that does not need a constant flow. Alternatively, the liquid in the reservoir may be continuously kept at the same level to maintain a constant hydrostatic pressure.

In other embodiments, passive injection may be controlled by pressure applied through the inlet geometry. For example, FIG. 6 illustrates a system 600 using inlet geometry 401 to inject fluid into a microfluidic channel 601, in accordance with embodiments of the invention. A pressure source 602 can pressurize microfluidic channel 601 through pressure channels 603. If the pressure provided by pressure source 602 equals the hydrostatic pressure of the fluid (ρgΔh) as shown in the left pane of FIG. 6, no fluid will flow. However, if the pressure provided by pressure source 602 is less than the hydrostatic pressure, then fluid will flow into microfluidic channel 603, as shown in the right panel of FIG. 6. Pressure source 602 may be able to apply a partial vacuum to pressure channels 603 as well.

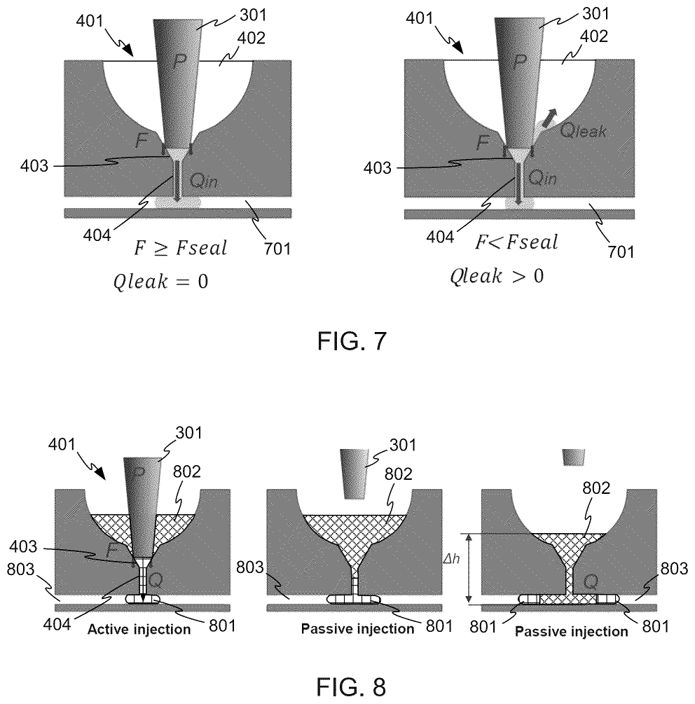

FIG. 7 illustrates active injection in a system using inlet geometry 401, in accordance with embodiments of the invention. Injector 301 is engaged with injection nozzle 403. Preferably, injector 301 is pressed into injection nozzle 403 with sufficient force F (greater than a value Fₛₑₐₗ) that injector 301 seals to injection nozzle 403 and fluid can be injected into microfluidic channel 701, under pressure supplied inside injector 301, without leakage into reservoir 402, as shown in the left panel of FIG. 7. In that case, air injection into injection channel 404 is also substantially or entirely prevented. However, if injector 301 is pressed into injection nozzle 403 with a force less than Fₛₑₐₗ, then leakage can occur, as shown in the right panel of FIG. 7.

In other embodiments, inlet geometry 401 may be used for combined active and passive injection. FIG. 8 shows an example of active injection of a first liquid 801, followed by passive injection of a second, different liquid 802, in accordance with embodiments of the invention. In the left panel of FIG. 8, injector 301 is pressed into injection nozzle 403 with a force F sufficient to seal injector 301 to injection nozzle 403, preventing contamination of second fluid 802 already in the reservoir. First liquid 801 is actively injected through injection nozzle 403 and injection channel 404, and flows to microfluidic channel 803.

As shown in the center panel of FIG. 8, injector 301 is then withdrawn, allowing second fluid 802 to passively enter injection channel 404. First fluid 801 is forced by second fluid 802 to continue to flow into microfluidic channel 803.

As shown in the right panel of FIG. 8, second fluid 802 continues to flow under the influence of gravity, forcing first fluid 801 further outward in microfluidic channel 803.

The combination of active and passive injection in a single device may allow for more efficient operation. For example, experiments may be performed in less time than with separate devices, with fewer components, and at lower cost. It will be understood that the active and passive injection shown in FIG. 8 could also be performed in the reverse order, with the passive injection coming before the active injection.

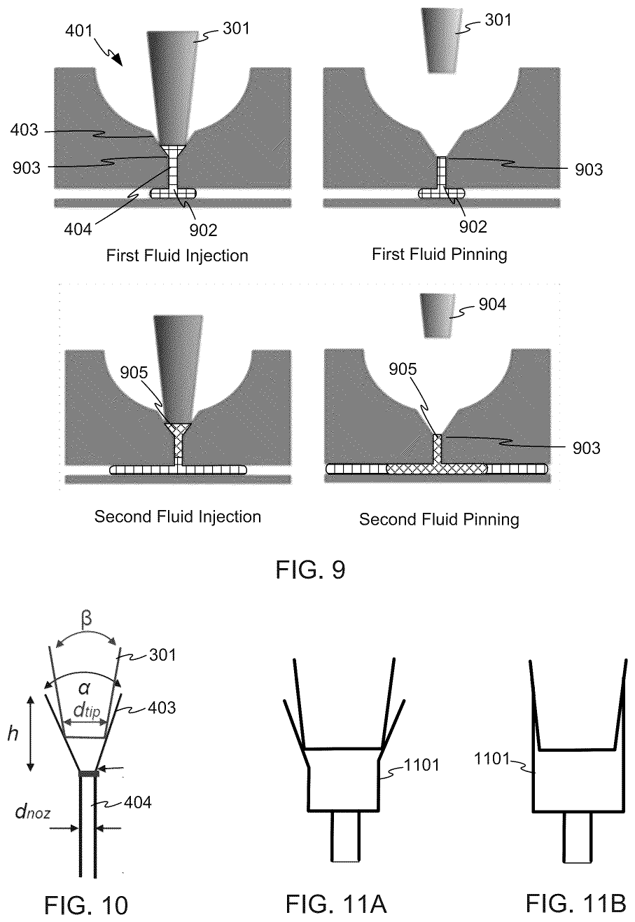

In other embodiments, sequential active injection may be performed. For example, FIG. 9 shows the sequential active injection of two different fluids into a microfluidic channel 901, in accordance with embodiments of the invention. In the upper left panel of

FIG. 9, labeled “First Fluid Injection”, a first fluid 902 is injected from injector 301 through injection nozzle 403 and injection channel 404, as described above. Injector 301 contacts injection nozzle 403 at a location higher than a pinning level 903, at which the injection nozzle 403 joins injection channel 404.

As shown in the upper right panel of FIG. 9, labeled “First Fluid Pinning”, when injector 301 is withdrawn, first fluid 902 is “pinned” at the pinning level 903 by capillary forces associated with the sharp geometric transition between injection nozzle 403 and injection channel 404.

Referring to FIG. 10, an example geometry is shown, in which aperture angle a of injection nozzle 403 is greater than tip convergence angle 13 of injector 301, allowing injector 301 to seal within injection nozzle 403 without leakage. Also, aperture angle a is less than or equal to 90 degrees, creating a sharp transition between injection nozzle 403 and injection channel 404. This enables the “pinning” of first fluid 902 at the transition. In addition, d_{nozz}<<dₜᵢₚ, which minimizes or eliminates injection of air into the system, and possible backflows.

Referring again to FIG. 9, a nozzle 904 is reinserted into injection nozzle 403, to inject a second fluid 905, as shown in the lower left panel of FIG. 9, labeled “Second Fluid Injection”. Finally, the lower right panel of FIG. 9, labeled “Second Fluid Pinning”, nozzle 904 is withdrawn and second fluid 905 also is pinned at the pinning level 903.

It will be recognized that the geometry of FIGS. 4-10 is but one example, and variations are possible. For example, FIGS. 11A and 11B show two alternative injection geometries, in which the injection nozzle includes straight sides 1101, either with a conic nozzle shape as shown in FIG. 11A, or without as shown in FIG. 11B.

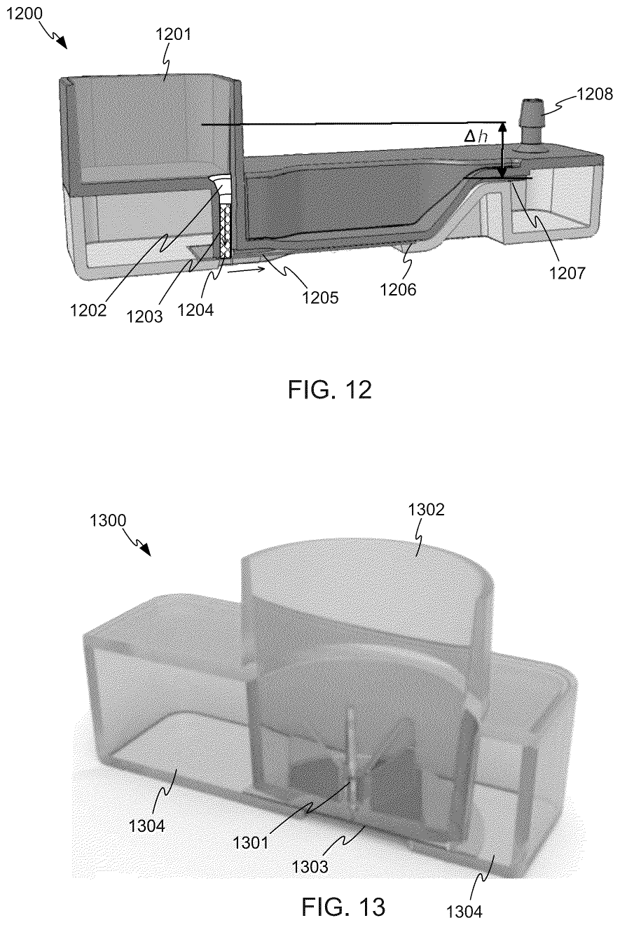

FIG. 12 shows the use of inlet geometry embodying the invention in a linear flow chamber device 1200, in accordance with other embodiments of the invention. In device 1200, liquid is initially held in a reservoir 1201. An injection nozzle 1202 is positioned at the bottom of reservoir 1201, and leads to an injection channel 1203. In some embodiments, injection nozzle 1202 and injection channel 1203 may be similar to injection nozzle 403 and injection channel 404 described above. Fluid 1204 can be actively injected through injection nozzle 1202 and injection channel as described above, for example using an injector similar to injector 301. Fluid may also be passively injected, by virtue of the height difference Δh between the fluid level in reservoir 1201 and the highest downstream point in the system 1207.

After injection, fluid 1204 flows horizontally through a reaction area 1205. A backflow preventer 1206 may be present, to ensure that fluid flows in only one direction through the system. Additional control over the flow through the system may be provided through a pressure port 1208. Sequential injection, using both active and passive injection is also possible, as described above.

FIG. 13 shows the use of inlet geometry embodying the invention in a radial splash device 1300, in accordance with other embodiments of the invention. In radial splash device 1300, inlet geometry 1301 is integrated upstream of a radial flow chamber microfluidic device, allowing passive injection, active injection, and sequential passive and active injection. Fluid is stored in a reservoir 1302 and flows through inlet geometry 1301 to a processing area 1303. Waste fluid flows outward to waste areas 1304. Pressure control may be provided downstream for control of passive injection.

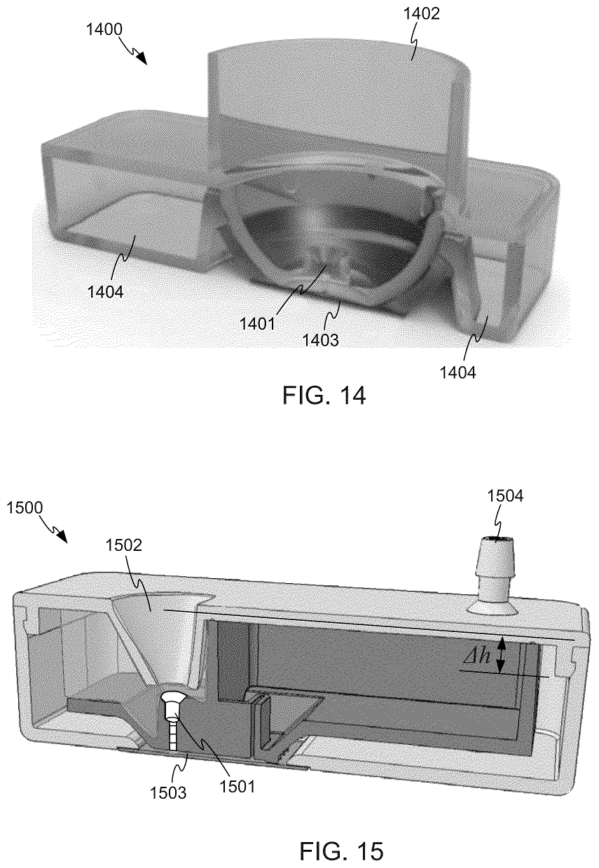

FIG. 14 shows the use of inlet geometry embodying the invention in a radial cup device 1400, in accordance with other embodiments of the invention. In radial cup device 1400, inlet geometry 1401 is integrated upstream of a radial flow chamber microfluidic device, allowing passive injection, active injection, and sequential passive and active injection. Fluid is stored in a reservoir 1402 and flows through inlet geometry 1401 to a confinement area 1403. Waste fluid flows outward to waste areas 1404. Pressure control may be provided downstream for control of passive injection.

FIG. 15 shows the use of inlet geometry embodying the invention with a hierarchical flow confinement (HFC) device, in accordance with embodiments of the invention. Inlet geometry 1501 is integrated upstream of the HFC device, allowing sequential active injection. In addition, the downstream channel features are in a lower position than the lower point of reservoir 1502, to allow for passive injection. Fluids flow from inlet geometry 1501 to a reaction area 1503. Pressure control features 1504 may be provided at the end of the downstream tubing, for control of passive injection.

### Microfluidic Device Washing

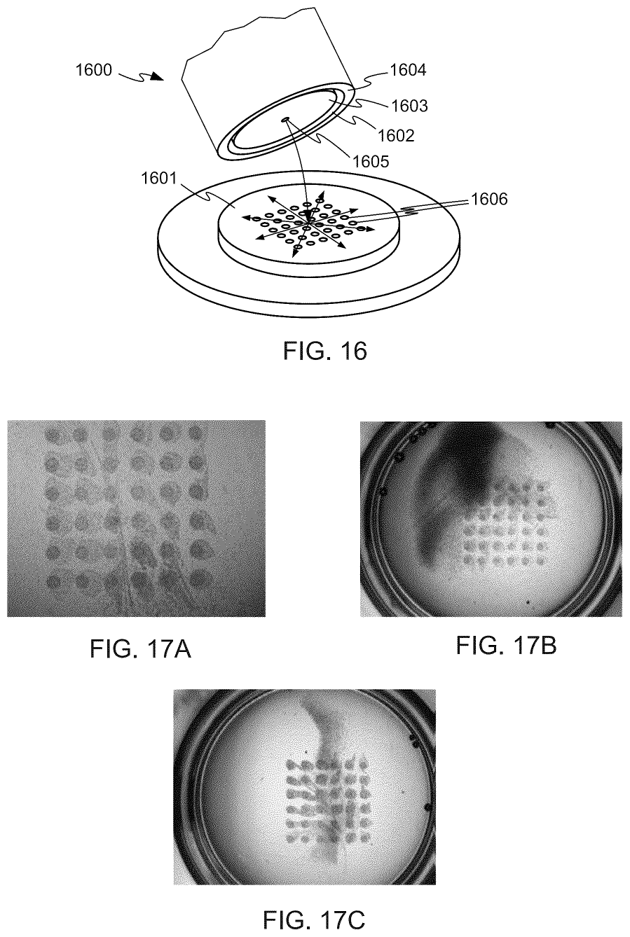

FIG. 16 illustrates a microfluidic probe 1600 for flowing a fluid across a surface 1601, in accordance with embodiments of the invention. Microfluidic probe 1600 is similar to microfluidic probe 100 described above, but includes an aspiration groove 1602 surrounding processing surface 1603, rather than aspiration channels within the processing surface. In operation, a perimeter 1604 of probe 1600 is held against surface 1601, and fluid is deposited on surface 1601 through central aperture 1605. The fluid flows outwardly from the injection point, and to aspiration groove 1602, where it may be aspirated away.

Surface 1601 has been spotted with antibodies in spots 1606. The injected fluid may contain, for example red blood cells, and the antibodies may bind to cells having a certain blood type, a certain disease characteristic, or another property of interest. Once sufficient fluid has flowed over spots 1606 for a sufficient period of time to permit binding to the antibodies, surface 1601 may be analyzed to determine the results of the test.

Preferably, excess fluid is removed from surface 1601 before the analysis, but existing cleaning procedures may not fully remove the excess fluid, for example due to a tendency to sediment to surface 1601. The relatively slow laminar flows from microfluidic probe 1600 may not fully overcome the tendency of the fluid to remain in place. And because the fluid may be optically dense, for example a fluid containing red blood cells, spots 1606 may be partially or completely obscured by the excess fluid, hindering the reading of the assay result. Incomplete washing and obscured spots may reduce the signal-to-noise ratio in the experiment, or require longer exposure times for optically reading a result.

FIGS. 17A-17C show examples of incomplete washing, including red blood cells deposited over the entire spot pattern as in FIG. 17A, or in localized areas as in FIG. 17B and FIG. 17C.

In accordance with embodiments of the invention, oscillatory vertical motion of the microfluidic probe is used to displace the injected fluid, to better remove surface particles. Preferably, the oscillations are accompanied by aspiration or a lateral reservoir to withdraw the particles detached from the surface. This technique works with both hard and deformable surfaces.

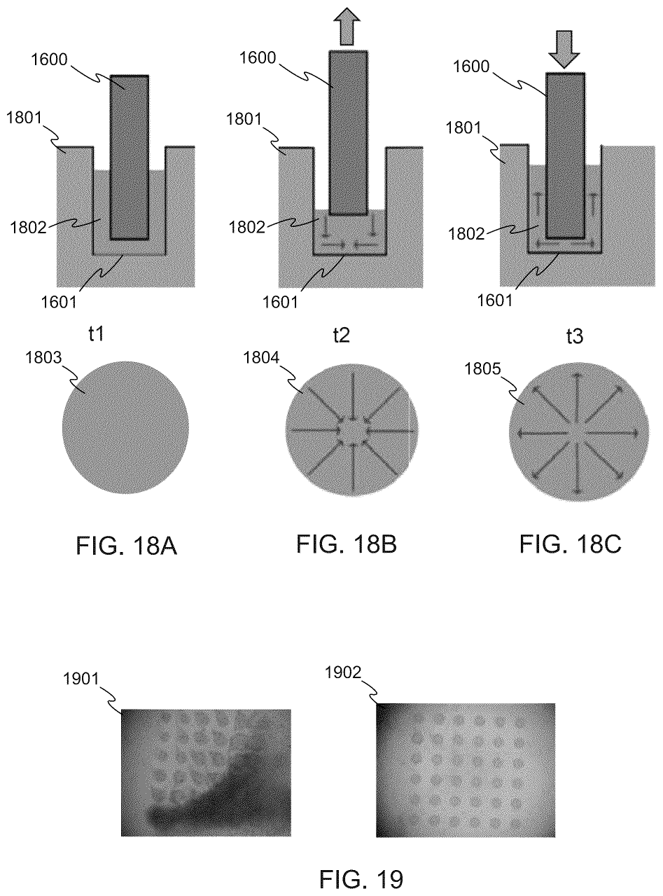

FIGS. 18A-18C show an oscillatory system and its operation, in accordance with embodiments of the invention. In this example system microfluidic probe 1600 and surface 1601 are surrounded by a wall 1801, and fluid 1802 is allowed to accumulate to partially submerge the lower end of microfluidic probe 1600.

In FIG. 18A, at a time t1, microfluidic probe 1600 is stationary, so no fluid motion occurs, as shown in top view 1803. In FIG. 18B, at a time t2, microfluidic probe 1600 moves upward, so that the level of fluid 1802 drops, and fluid flows across surface 1601 toward its center, as shown in top view 1804. In FIG. 18C, at a time t3, microfluidic probe 1600 moves downward, forcing fluid away from the center of surface 1601 as shown in top view 1805, and upward around microfluidic probe 1600.

This oscillation technique may have any or all of several advantages. For example, it may reduce the total processing time for an assay by removing sedimented particles faster than simple liquid flows. Surfaces obtained using this method present a reduced number of non-specifically bound particles. The technique is relatively easy to implement, and is superficially gentle to avoid detachment of specifically bound cells.

FIG. 19 shows a comparison of a surface 1901 washed using only aspiration, with a surface 1902 washed using aspiration plus the vertical displacement technique in accordance with embodiments of the invention.

Any suitable number of oscillations, oscillation speed, or other parameters may be used, but the following have been noted.
At least three oscillations may be used for significant effect, preferably three oscillations separated in time by 10-60 seconds.
Light contact with the surface can increase the washing efficiency. However, elements that separate the device from the reaction area should be present to avoid damage to the surface.
Larger traveling distances have stronger effects. In one example embodiment, the probe moves between a position touching the surface and a position 700 μm above the surface.
Injection of a buffer solution through the microfluidic probe may increase the washing effect.
Aspiration is preferably performed while the oscillation takes place. Aspiration may be through a central aperture of the microfluidic probe, through peripheral sides of the device, or both. Aspiration may be accomplished using pressure around the microfluidic probe, or using partial vacuum through the microfluidic probe. Any suitable aspiration rate may be used, but in some embodiments, the rate may be between −5 and −500 μL/min. The exact rate may be selected in part to avoid damage to the reaction area.

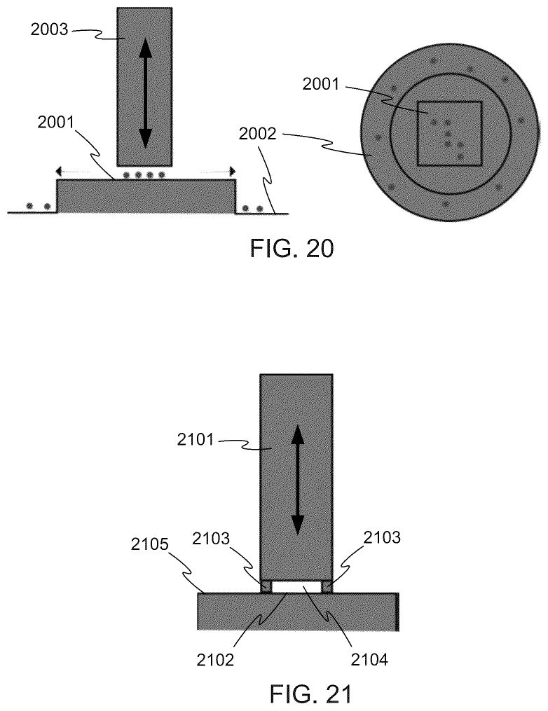

FIG. 20 illustrates another structure for disposal of particles washed from the reaction area, in accordance with other embodiments of the invention. The left panel of FIG. 20 shows a side view, and the right panel of FIG. 20 shows a top view of the system. In this embodiment, a reaction area 2001 is disposed above a surrounding particle disposal structure 2002. As microfluidic probe 2003 is oscillated, preferably while injecting washing solution to reaction are 2001, particles are forced toward the periphery of reaction area 2001 and fall into particle disposal structure 2002. Preferably, reaction area 2001 is at least 100 μm higher than particle disposal structure 2002, to prevent particles from being pulled back into reaction area 2001 when microfluidic probe 2003 is lifted.

FIG. 21 illustrates the use of stopping structures, to avoid damage to a reaction area, in accordance with embodiments of the invention. In this example embodiment, a microfluidic probe 2101 is configured to oscillate vertically above a reaction area 2102. Stopping structures 2103 are provided so that the center of microfluidic probe 2101 does not touch reaction area 2102, and a gap 2104 remains between reaction area 2102 and a working surface of microfluidic probe 2101, even when microfluidic probe 2101 is at its lowest position in which stopping structures 2103 may touch surface 2105. Stopping structures 2103 may be, for example “feet” on a bottom surface of microfluidic probe 2101, or may be a raised perimeter such as annular surface 103 shown in FIG. 1.

While stopping structures 2103 are shown as being part of microfluidic probe 2101, in other embodiments, they may integrated with or attached to surface 2105. Surface 2105 may be a membrane, which may displace to preserve gap 2104 when contacted by microfluidic probe 2101, and which may transfer kinetic energy of microfluidic probe 2101 to the membrane.

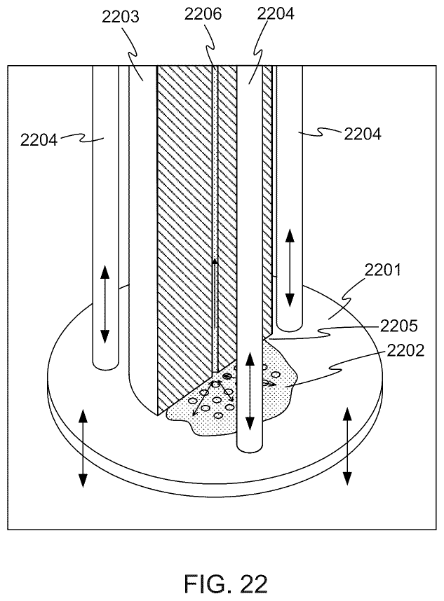

In other embodiments, the surface on which antibodies are spotted may be oscillated in relation to the microfluidic probe to cause fluid flow across the surface, rather than vertically oscillating the probe itself. For example, in FIG. 22 a surface 2201 has been spotted with antibodies, and fluid 2202 has been flowed across surface 2201 using a microfluidic probe 2203 (shown in cross section). Additional oscillation structures 2204 surround microfluidic probe 2203, and can be lowered to contact surface 2201.

Embodiments similar to the one shown in FIG. 22 may be especially useful when surface 2201 is a membrane, rather than a rigid glass plate or other structure.

Once in contact with surface 2201, oscillation structures are oscillated vertically, for example using a motion stage, causing surface 2201 to also oscillate vertically. The oscillation of surface 2201 causes cyclic variation in the size of gap 2205 between microfluidic probe 2203 and surface 2201, which causes fluid 2202 to oscillate inward and outward from central aperture 2206 of microfluidic probe 2203. The moving fluid tends to wash surface 2201 to dislodge any sedimented particles. Aspiration through central aperture 2206 may occur at the same time, to carry dislodged particles away.

While oscillation structures 2204 are shown as being cylindrical, they may be any workable shape, for example rectangular. Preferably, oscillation structures 2204 are placed within 5 mm of microfluidic probe 2203, and have a diameter between 1/32 and ⅕ of the diameter of microfluidic probe 2203, although this is not a requirement. At least 2, and preferably three or more oscillation structures are provided, surrounding microfluidic probe 2203. Oscillation structures 2204 may be made of any suitable material, but may conveniently be made of the same material as microfluidic probe 2203.

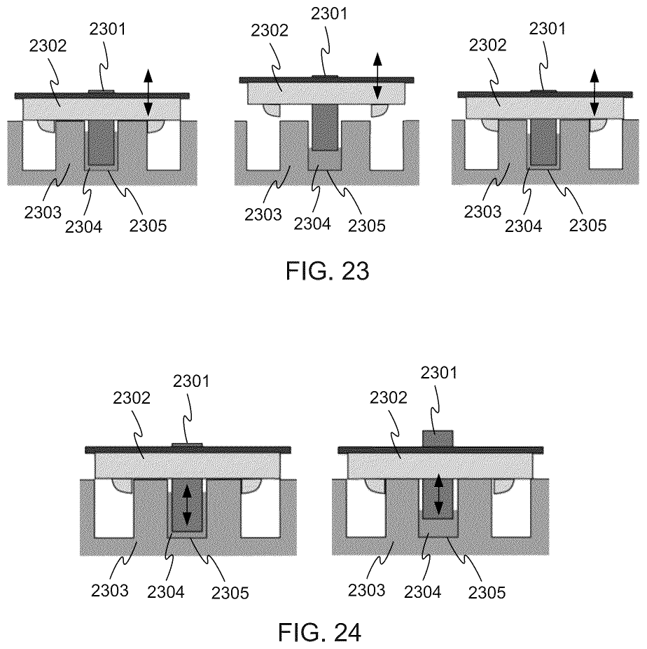

In other embodiments, an oscillatory device can be combined with a self-aligning system. For example, FIG. 23 shows a system in accordance with embodiments of the invention, in which a microfluidic probe 2301 is carried by a frame 2302 that self-aligns to a receptacle 2303, containing the working fluid 2304 and spotted surface 2305.

In the left panel of FIG. 23, frame 2302 and microfluidic probe 2301 are at a lower position, and fluid 2304 has surrounded part of microfluidic probe 2301. In the center panel of FIG. 23, frame 2302 and microfluidic probe 2301 have moved to an upper position, causing fluid 2304 to flow inwardly toward a center of surface 2305, promoting washing of surface 2305. In the right panel of FIG. 23, frame 2302 and microfluidic probe 2301 have returned to the lower position, causing fluid 2304 to flow outwardly from the center of surface 2305.

FIG. 24 shows an alternative arrangement in accordance with other embodiments of the invention, in which the frame 2302 remains fixed in relation to receptacle 2303, and microfluidic probe 2301 oscillates vertically in relation to frame 2302.

### Integration of Functionalized Substrates

Assays as described thus far often include the steps of functionalizing a surface, and then flowing a fluid over the surface. In this context, “functionalizing” the surface may include spotting the surface with antibodies specific to an analyte carried in the flowing fluid, or spotting the surface with an analyte to be subjected to a flowing fluid carrying antibodies, or the like.

In any event, the functionalized surface is often part of a larger structure including flow channels, reservoirs, overflow areas, and the like.

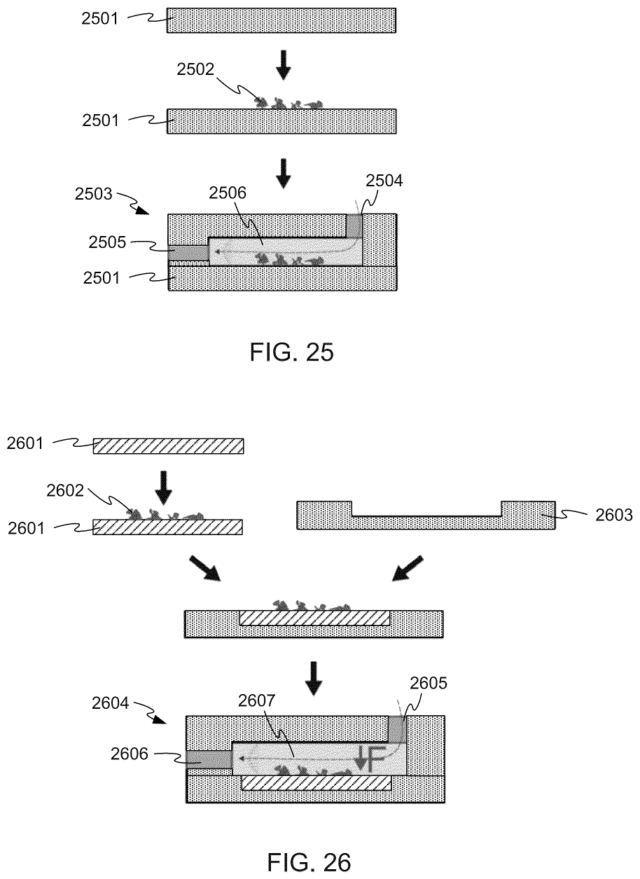

For example, FIG. 25 shows a conventional process and device, in which a substrate 2501 is functionalized by spotting it with antibodies 2502. The substrate 2501 is assembled into a structure 2503 having an inlet port 2504, and outlet port 2505, and a microfluidic channel 2506 through which fluid flows during an assay. Traditionally, the entire structure 2503 may be discarded after an assay. In addition, a substrate material selected for its mechanical properties may constrain the kind of functionalization that may be performed it, constraining the kinds of assays that may be performed.

In accordance with other embodiments of the invention, surfaces may be provided on modular portions of a device, for example on a membrane or rigid piece assembled into the device. The modular portion may be made of a different material than the rest of the structure, providing additional flexibility in the kinds of assays that can be performed with the device.

FIG. 26 illustrates this process, in accordance with embodiments of the invention. A modular substrate 2601 such as a membrane or other substrate is functionalized, for example by spotting it with antibodies 2602. Functionalized substrate 2601 is joined with device geometry 2603, and then assembled into a completed device 2604, having an inlet port 2605, an outlet port 2606, and a microfluidic channel 2607.

In this way, the process of substrate functionalization becomes independent of the properties of the device support material. This can result in increased versatility of the device/assay, because the same device geometry can integrate different substrates for different assays. The functionalization procedures may be optimized, resulting in savings in time and cost. Also, because the support material need not be functionalized, the device geometry production may be optimized, also resulting is time and cost benefits.

The functionalized substrate may be integrated inside the device through a geometrical feature present on one part of the device geometry, for example the bottom part.

To allow for the integration of the functionalized membrane, the device may preferably be composed of two or more independent parts with independent geometries, made of the support material. A force F may be applied from the device geometry on the inserted substrate to hold it in the correct position, to ensure the desired fluid dynamic. For example, it may be desirable to prevent leaks, provide linear flow, and to provide a smooth transition of flow from support material to membrane.

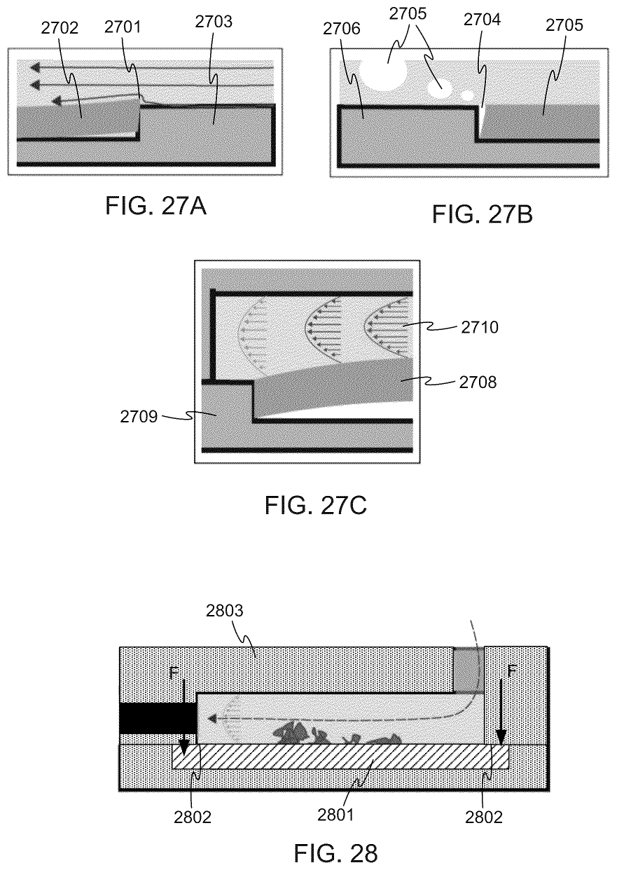

FIGS. 27A-27C illustrate various detrimental effects that can occur if a functionalized modular substrate is not held correctly in a device. For example, in FIG. 27A, an edge 2701 of a substrate 2702 is not aligned with the surface of the supporting structure 2703, which can result in a disrupted flow profile near the edge 2701. In FIG. 27B, a gap 2704 exists between a modular substrate 2705 and supporting structure 2706. Such a gap can result in poor filling of the device, disruption or alteration of fluid flow, and formation of bubbles 2707. In FIG. 27C, a modular substrate 2708 does not lie flat within supporting structure 2709, causing a variable flow channel height and a variable flow profile 2710, which can result in uneven binding of analytes and antibodies.

FIG. 28 illustrates a technique for holding a functionalized substrate in a supporting structure, in accordance with embodiments of the invention. In FIG. 28, functionalized modular substrate 2801 extends outward under edges 2802 of upper structure 2803. Force F may be transmitted by any workable means and in any workable location. For example, additional or alternative forces may be applied near the center of substrate 2801, to avoid bending. Elastic materials, for example rubber 0-rings or gaskets, may be placed to regulate the force applied to substrate 2801.

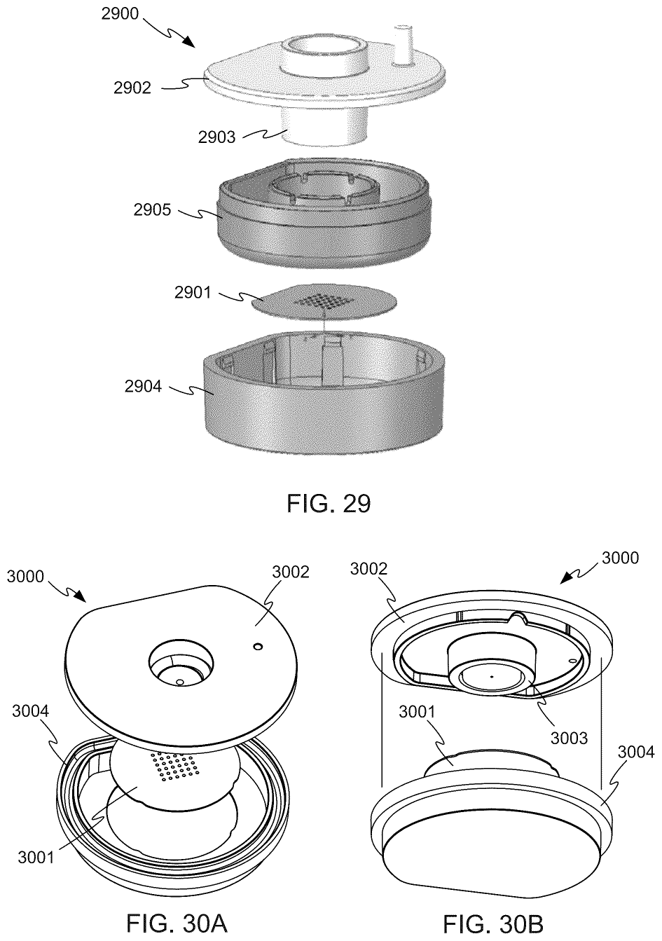

FIG. 29 shows an exploded view of a device 2900 that holds a functionalized substrate 2901, in accordance with embodiments of the invention. Top portion 2902 of the device has a descending member 2903, which includes injection geometry, but also holds functionalized substrate 2901 against the floor of lower portion 2904 when device 2900 is fully assembled. A collection cup 2905 may optionally fit between top portion 2902 and lower portion 2904.

FIG. 30A and FIG. 30B show upper and lower exploded views of a device 3000 that holds a functionalized substrate 3001, in accordance with embodiments of the invention. Device 3000 includes a top portion 3002 having a descending member 3003. Device 3000 also has a cup-shaped bottom portion 3004.

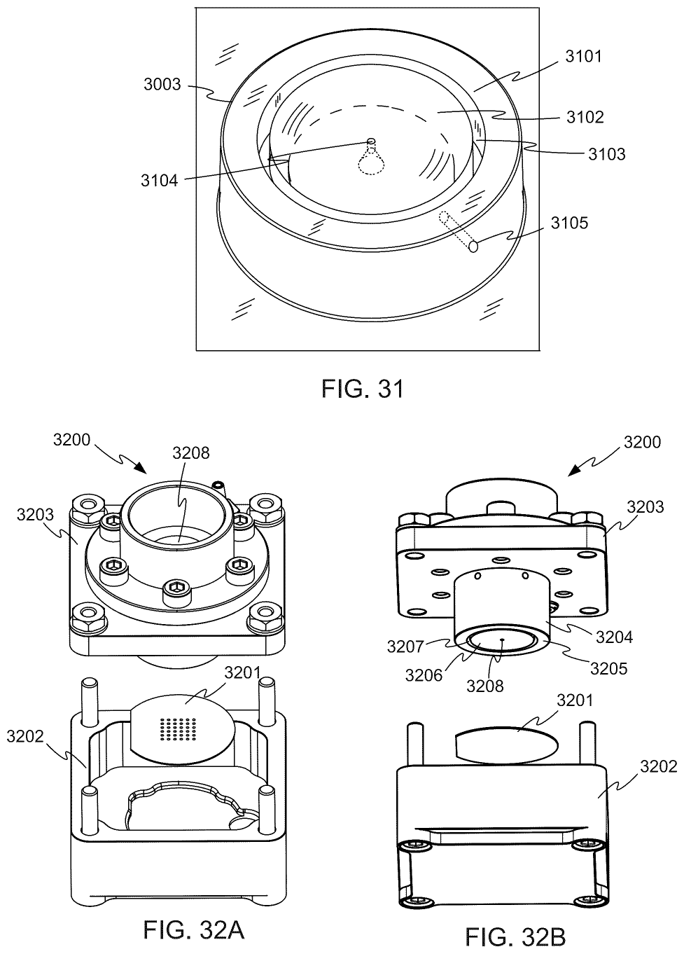

FIG. 31 shows descending member 3003 in more detail, from below. Perimeter surface 3101 is the surface that pins functionalized substrate 3001 to the bottom portion 3004 when the device is assembled. Processing surface 3102 is surrounded by an aspiration groove 3103, and includes inlet geometry 3104, which may be similar to any of the geometries described above. Processing surface 3102 is preferably recessed slightly below perimeter surface 3101, so that a microfluidic gap exists between processing surface 3102 and functionalized substrate 3001.

An outlet 3105 is also visible, for carrying aspirated fluid out of groove 3103, for collection in lower portion 3004.

While devices 2900 and 3000 are shown as being generally circular, this is not a requirement, and other geometries may be used in accordance with other embodiments of the invention. For example, FIG. 32A and FIG. 32B show a microfluidic device 3200 that is generally rectangular, in a disassembled state. A functionalized substrate 3201 can be placed between a base 3202 and an upper portion 3203. A descending member 3204 includes a perimeter surface 3205 and a processing surface 3206, separated by an aspiration groove 3207. Inlet geometry 3208 is provided in upper portion 3203, and may be similar to any of the geometries described above.

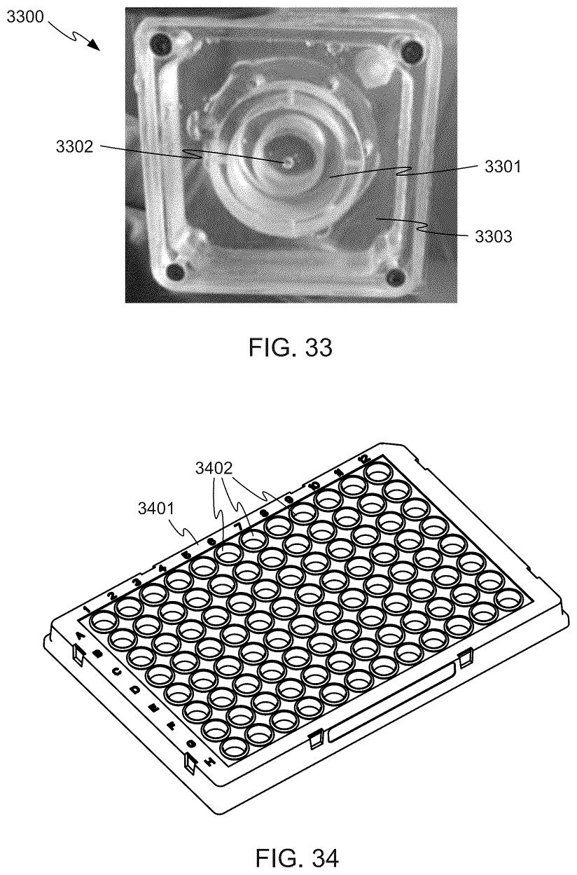

FIG. 33 shows another microfluidic device 3300, in accordance with other embodiments of the invention. Microfluidic device 3300 is generally square in shape, and is shown from below and in use. Fluid 3301 (shown in green) is being dispensed from inlet geometry 3302, and is visible through transparent bottom cover 3303 of device 3300.

FIGS. 34-37 illustrate a microfluidic device according to other embodiments of the invention, having geometry similar to that of a standard 96-well microtiter plate. FIG. 34 shows a standard 96-well microtiter plate 3401. Example microtiter plate 3401 has a footprint of about 127×86 mm, with 96 wells 3402 arranged in 12 rows of eight wells, the wells being spaced 9 mm apart in both directions. Other dimensions and numbers of wells are possible.

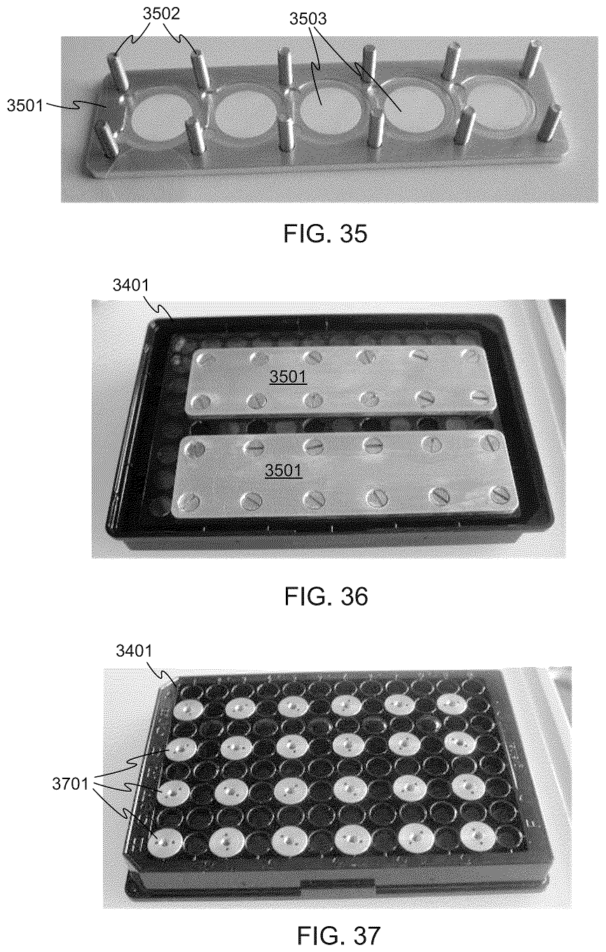

FIG. 35 illustrates a clamping plate 3501, having 12 threaded posts 3502 on 18 mm centers. Clamping plate 3501 also defines five receiving areas 3503, for receiving functionalized substrates for microfluidic processing. Two clamping plates 3501 may be mounted to a modified microtiter plate 3401, as shown in FIG. 36 from the bottom side of microtiter plate 3401 and clamping plates 3501. Threaded posts 3502 are not visible in FIG. 36, but are inserted through openings corresponding to alternate wells 3402 in microtiter plate 3401.

FIG. 37 shows the assembly from the top side, including screws 3701 that engage threaded posts 3502 (not visible) to clamp microtiter plate 3401 to receiving areas 3503. Receiving areas 3503 are under the wells 3402 centered between four adjacent screws 3701.

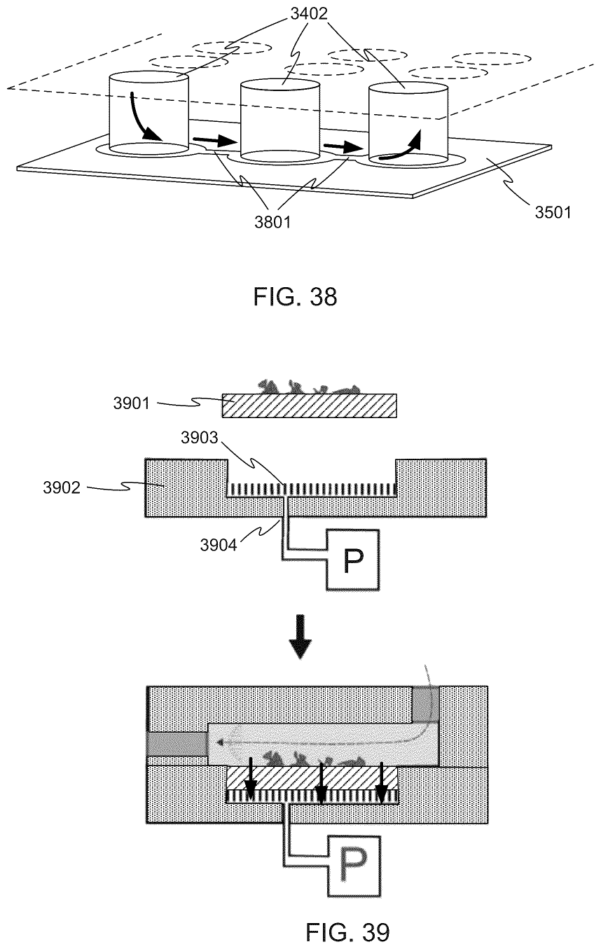

Each of the wells 3402 over a reception area 3503 may be an independent chamber, or in other embodiments, reception areas 3503 may have channels connecting them, enabling flow from one receiving area to the next. For example, FIG. 38 shows a sketch of a system having flow channels 3801 between the reception areas corresponding to adjacent wells 3402.

FIGS. 39-41 illustrate additional ways of holding a functionalized surface in a microfluidic device, in accordance with other embodiments.

For example, in FIG. 39, a functionalized substrate 3901 is assembled into structure 3902 in accordance with other embodiments of the invention. Structure 3902 has porous features 3903 and a gas channel 3904. Porous features 3903 may be, for example pillars or gratings, a porous material, or other features that enable air flow dispersed over an area. A pressure control P can pull air through porous features 3903 and gas channel 3904, to pull substrate 3901 firmly into structure 3902, as shown in the lower panel of FIG. 39. The pressure control may be adjustable.

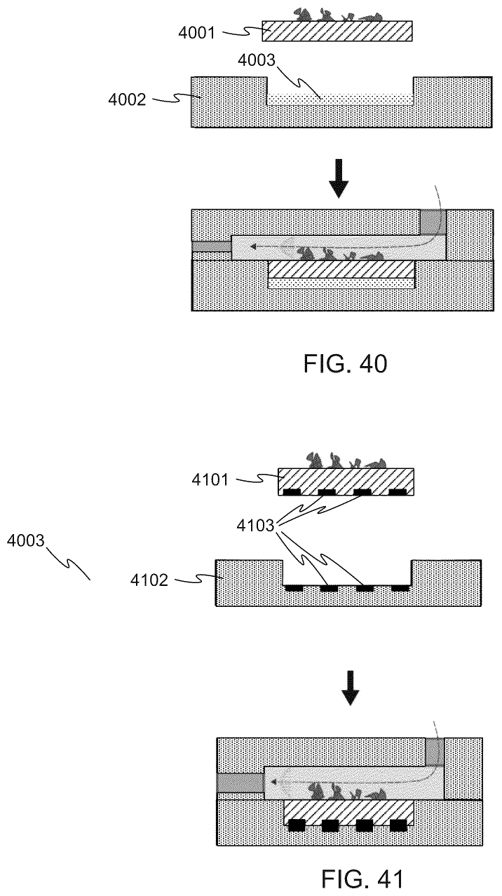

In FIG. 40, a functionalized substrate 4001 is assembled into structure 4002 using an adhesive material 4003, in accordance with embodiments of the invention. Adhesive material 4003 may comprise a resin, a thermoplastic epoxy, or other polymers, or other kinds of adhesive. Any workable adhesive may be used.

In FIG. 41, a functionalized substrate 4101 is held into structure 4102 using one or more magnets 4103, in accordance with embodiments of the invention. Magnets 4103 may be, for example, neodymium-iron-boron magnets, or another suitable kind of magnet. The strength of magnets 4103 may be selected to apply sufficient force for operation of the device, while allowing reasonable disassembly of the device, if desired.

In other embodiments, electrostatic interaction may be used to hold a functionalized substrate into other structure. For example, generation of static charges on the bottom surface of the substrate and on the supporting surface of the supporting geometry may be accomplished using the triboelectric effect, so that a net electrostatic attraction force is created.

### EXPERIMENTS

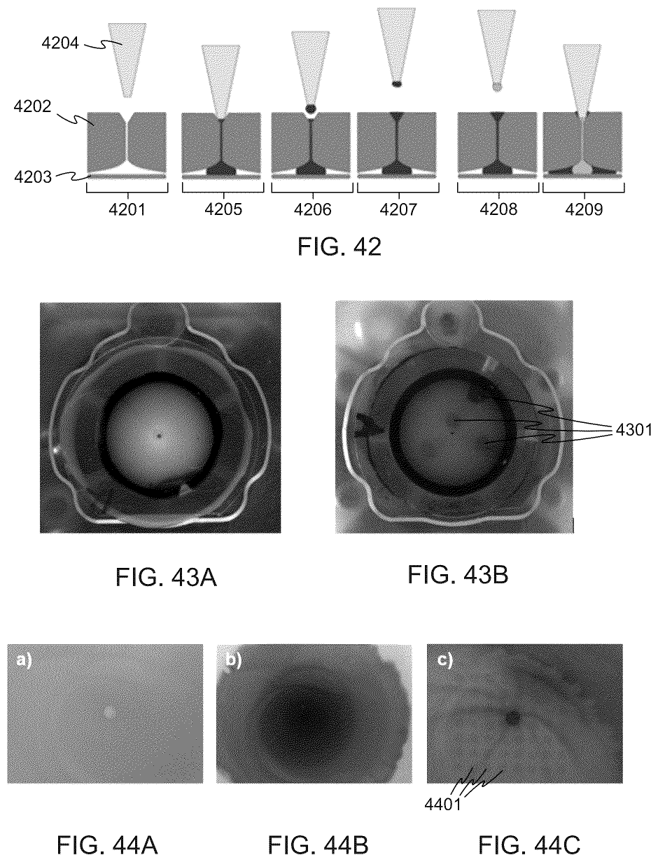

FIGS. 42-45 show a process of using devices as described above, and results obtained thereby. Two experiments are shown, both using red blood cells (RBCs) in the fluid to be tested.

In preparation, sample tubes of blood were centrifuged 5 minutes at 3000 g, to separate the red cells from the blood serum. Then, 1 ml of packed RBCs were diluted in 1 ml of NaCl 0.9%.

Experiments have shown that low flow rates, for example 10 μl/min, into a microfluidic device as described above did not result in homogeneous filling of the gap between the processing surface and the functionalized membrane surface. However, low flow rates are desirable to minimize the shear stress on RBCs, which could lead to sample hemolysis.

In the experiments described herein, sample injection was performed in two stages—a first stage having a high flow rate, and a second stage having a low flow rate. For example, to inject 80 μl of sample, the first 20 μl may be injected at 100 μl/min, and the remaining 60 μl injected at rate of 10 μl/min. Other flow rates may be used as well. This two-stage process results in more homogeneous filling of the device. In addition, no remarkable difference in fluidic behavior was observed between 1 day-old and 3 day-old samples.

In a first experiment, membranes were manually spotted with anti-D (don BRAD-3, 1 μμl per spot, plus fixing solution). There were five spots per membrane. The spotted membranes were refrigerated until just prior to use. The steps of the experiment were as follows, and are illustrated in FIG. 42.

At step 4201, a microfluidic device 4202 and a functionalized substrate 4203 are in position to receive sample fluid from an injection nozzle 4204.

At step 4205, 50% RBCs dilution is injected into microfluidic device 4202 for five minutes. The first 15 μl of sample is injected at 100 μl/min, and the remainder is injected at 10 μl/min.

At step 4206, injection nozzle 4204 is withdrawn.

At steps 4207 and 4208, the RBC dilution is allowed to sediment for two minutes over the membrane. Injection nozzle 4204 may be washed (not shown).

At step 4209, NaCl 0.9% is used as washing solution and it is injected into microfluidic device 4202 at a flow rate of 10 μl/min for two minutes.

FIGS. 43A and 43B show two possible results of the test. In FIG. 43A, O-RBCs were injected on the microfluidic device. Since there is no antigen D on the cellular membrane, the cells do not bind to the antibodies fixed on the membrane and the result is a completely clean surface of the device.

In FIG. 43B, O+RBCs were injected, and five spots 4301 are clearly visible (although not all of them are labeled). Notably, the image shows low unspecific binding outside the spotted area, which means that the washing procedure is effective and it does not damage the cells immobilized on the surface.

In a second experiment, automatically-spotted membranes were used, spotted with anti-e (clone BS260 at 100 μg/ml plus fixing solution). Each membrane had 64 spots. The membranes were refrigerated and held under vacuum until just before the experiment. The injection protocol was the same as for the first experiment above, illustrated in FIG. 42. For the second experiment, the samples used were QC tubes, IH-QC 1 and IH-QC 2, since their genotypes are ddccee and DCcEe, respectively. Both samples are expected to positively react with the membranes.

FIGS. 44A-44C show different phases in the second experiments, as photographs from below the membrane. In FIG. 44A, sample injection has not yet occurred. The membrane is clean and the spots are not visible.

In FIG. 44B, the RBCs dilution is injected over the membrane and allowed to sediment about two minutes. In FIG. 44C, washing is in progress and the spots 4401 (only a few of which are labeled) are already visible.

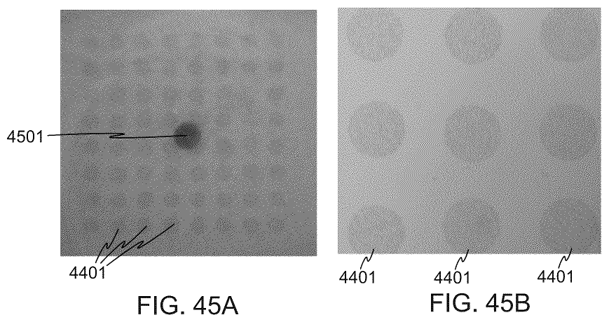

FIG. 45A shows RBCs bound on top of the membrane. The red spot 4501 at the center of the image is the inlet of the microfluidic device. Some residues of the RBCs dilution remain in the inlet and they are visible at the end of the test.

FIG. 45B shows some of the spots 4401 as microscopically imaged at 4× magnification. As is evident, the spots are very well shaped, and unspecific binding has not occurred.

It will be apparent to those skilled in the art that various modifications and variations can be made in the method and system of the present invention without departing from the spirit or scope of the invention. Thus, it is intended that the present invention include modifications and variations that are within the scope of the appended claims and their equivalents. It is to be understood that any workable combination of the features and capabilities disclosed herein is also considered to be disclosed.

What is claimed is:

1. A microfluidic device having inlet geometry, the inlet geometry comprising:
a reservoir;
an injection nozzle at the bottom of the reservoir, the injection nozzle being wider at its top than at its bottom;
an injection channel below the injection nozzle; and
a microfluidic channel below the injection channel.

2. The microfluidic device of claim 1, further comprising:
at least one pressure channel coupled to the microfluidic channel; and
a pressure source coupled to the pressure channel and configured to regulate pressure in the microfluidic channel via the pressure channel.

3. The microfluidic device of claim 1, wherein the microfluidic device is a linear flow chamber device.

4. The microfluidic device of claim 1, wherein the microfluidic device is a radial splash device.

5. The microfluidic device of claim 1, wherein the microfluidic device is a radial cup device.

6. The microfluidic device of claim 1, wherein the microfluidic device is a hierarchical flow confinement device.

7. A method, comprising:
providing a microfluidic device including a reservoir; an injection nozzle at the bottom of the reservoir, the injection nozzle being wider at its top than at its bottom; an injection channel below the injection nozzle; and a microfluidic channel below the injection channel;
placing fluid in the reservoir; and
allowing the fluid to passively flow through the injection nozzle and the injection channel.

8. The method of claim 7, further comprising:
placing an injector into the injection nozzle; and
actively injecting a second fluid from the injector into the injection nozzle.

9. A method, comprising:
providing a microfluidic device including a reservoir; an injection nozzle at the bottom of the reservoir, the injection nozzle being wider at its top than at its bottom; an injection channel below the injection nozzle; and a microfluidic channel below the injection channel;
placing an injector into the injection nozzle; and
actively injecting a second fluid from the injector into the injection nozzle.

10. A method, comprising:
injecting fluid onto a surface using a microfluidic probe; and
oscillating the microfluidic probe vertically to facilitate washing of the surface.

11. The method of claim 10, further comprising flooding a tip of the microfluidic probe with fluid.

12. A microfluidic device, comprising:
a supporting structure; and
a modular functionalized substrate mounted to the supporting structure.

13. The microfluidic device of claim 12, wherein the modular functionalized substrate is clamped between members of the supporting structure.

14. The microfluidic device of claim 12, wherein the microfluidic device is in the shape of a standard microtiter plate.

15. The microfluidic device of claim 12, wherein the modular functionalized substrate is held to the supporting structure by a pressure differential.

16. The microfluidic device of claim 12, wherein the modular functionalized substrate is held to the supporting structure by a one or more magnets.
